(19) United States
(12) Patent Application Publication
(10) Pub. No.: US 2005/0113110 A1
(43) Pub. Date: May 26, 2005

(54) Bidirectional positioning system for ubiquitous computing

(76) Inventors: Inone Joo, Jeollabuk-Do (KR); Wan-Sik Choi, Daejon (KR); Jae-Hoon Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,735

(22) Filed: Jun. 30, 2004

(30) Foreign Application Priority Data
Nov. 21, 2003 (KR) 2003-83200

(51) Int. Cl. H04B 7/005

(52) U.S. Cl. 455/456.1

(57) ABSTRACT

A bidirectional positioning system is disclosed. The system having a plurality of mobile stations radiating ultrasonic signals to notice a physical location of correspondence mobile station and to request additional information, the bidirectional positioning system, including: a plurality of ultrasonic transceivers for receiving the ultrasonic signal from the plurality of mobile stations and measuring a receiving time of the ultrasonic signal with a correspondence mobile station; and a positioning server for computing physical locations of the plurality of mobile stations by collecting three or more receiving times of correspondence mobile station from the plurality of ultrasonic transceivers, storing the computed physical locations of the plurality of mobile stations in a database, generating a radio frequency (RF) information signal to have information about computed physical location of the mobile stations by receiving the ultrasonic signal from the plurality of ultrasonic transceivers and transmitting the RF information signal to the mobile stations.

### FIELD OF THE INVENTION

The present invention relates to a positioning system; and, more particularly, to a bidirectional positioning system for a ubiquitous computing, a method thereof and a recording medium recorded therein a program for implementing the method.

### DESCRIPTION OF RELATED ARTS

In the ubiquitous computing environment, objects, e.g., a road, a bridge, a tunnel and a building, are intellectualized by installing a micro computer into the objects in order to communicate with each other by forming an information network with neighbor objects. For implementing the ubiquitous computing environment, a positioning system is required to indicate a physical location of each object to form a communication network. Conventionally, a global positioning system (GPS) has been widely used. The GPS computes the physical location of an object based on a triangulation method by receiving at least three satellite signals with time information from three different satellites. However, the GPS cannot computes the physical location of an object located at a place where the satellite signals could not be arrived such as indoor places of a building.

For overcoming above described limitation of the GPS, a hybrid positioning system has been developed. The hybrid positioning system computes the physical location of a mobile station located at the indoor place by using a signal transmitted from a base station combined with a satellite signal. However, the hybrid positioning system cannot accurately compute the physical location of the objects since the signal transmitted from the base station is easily distorted according to environment factors of the mobile station such as a shadow area. Also, the mobile station is generally heavy and large and consumes a mass amount of electric power.

Therefore, a small sized positioning system of high accuracy has been studied.

FIG. 1 is a block diagram showing a conventional positioning system.

The conventional positioning system 100, called as an active bat, has been introduced by the AT&T and computes a physical location of objects by using a triangulation method with an ultrasonic wave.

The conventional positioning system 100 includes a server 110, a plurality of ultrasonic transceivers 120A to 120D installed at an indoor place A and a plurality of mobile stations 130A to 130N capable of transmitting the ultrasonic wave.

The server 110 is connected to the plurality of ultrasonic transceivers 120A to 120D and transmits a reference signal to the plurality of ultrasonic transceivers 120A to 120D through wired communication channels. The server 110 includes a radio frequency (RF) transmitter 111 for transmitting a RF information signal to the plurality of mobile stations 130A to 130N through a wireless communication channel.

Each of the mobile stations 130A to 130N transmits an ultrasonic signal, which is an ultrasonic wave, to the plurality of ultrasonic transceivers 120A to 120D and the plurality of ultrasonic transceivers 120A to 120D measures a receiving time of the ultrasonic signal corresponding to a mobile station which radiates the ultrasonic signal.

The server 110 collects the receiving times of the plurality of mobile stations 130A to 130N from the plurality of the ultrasonic transceivers 120A to 120D, which are varied according to the movement of each of the mobile stations 130A to 130N, and detects a physical location of each of the mobile stations 130A to 130N by using the triangulation method based on the collected receiving times.

As described above, the conventional positioning system 100 can accurately computes the physical position of each of the mobile stations 130A to 130N by using an ultrasonic wave, but each of the mobile stations 130A to 130N does not have information of own physical location information since the server 110 computes physical locations of the mobile stations 130A to 130N.

### SUMMARY OF THE INVENTION

It is, therefore, an object of the present invention to provide a bidirectional positioning system for accurately computing a physical location of a mobile station by using an ultrasonic signal radiated from the mobile station.

It is another object of the present invention to provide a bidirectional positioning system for transmitting information about a physical location of a mobile station to mobile stations in order to share the information about physical locations of mobile stations with a positioning server and the mobile stations.

It is still another object of the present invention to provide a bidirectional positioning method and a computer readable recoding medium storing instructions to execute the bidirectional positioning method for accurately computing a physical location of a mobile station by using an ultrasonic signal radiated form the mobile station, and for transmitting information about computed physical locations to mobile stations in order to share the information with a positioning server and the mobile stations.

In accordance with an aspect of the present invention, there is provided a bidirectional positioning system including a plurality of mobile stations radiating ultrasonic signals to notice a physical location of correspondence mobile station and to request additional information, the bidirectional positioning system, including: a plurality of ultrasonic transceivers for receiving the ultrasonic signal from the plurality of mobile stations and measuring a receiving time of the ultrasonic signal with a correspondence mobile station; and a positioning server for computing physical locations of the plurality of mobile stations by collecting three or more receiving times of correspondence mobile station from the plurality of ultrasonic transceivers, storing the computed physical locations of the plurality of mobile stations in a database, generating a radio frequency (RF) information signal to have information about computed physical location of the mobile stations by receiving the ultrasonic signal from the plurality of ultrasonic transceivers and transmitting the RF information signal to the mobile stations.

In accordance with an aspect of the present invention, there is also provided a method for computing a physical location of mobile stations and sharing information including the physical location in a bidirectional positioning system, the method including the steps of: a) at a positioning server, providing a reference time to a mobile station by transmitting a radio frequency (RF) information signal with the reference time through a wireless communication channel, and providing the reference time to a plurality of ultrasonic transceivers by transmitting a reference signal with the reference time through a wired communication channel; b) at a plurality of ultrasonic transceivers, measuring receiving times with correspondence mobile stations by receiving the ultrasonic signal and delivering the measured receiving times and the ultrasonic signal to the positioning server; c) at the positioning sever, computing physical locations of the mobile stations by receiving the receiving times of correspondence mobile stations from at least three different ultrasonic transceivers, storing the computed physical locations of the mobile stations and allocating an access channel to the mobile station; and d) at the positioning server, generating a radio frequency (RF) information signal by inserting information about the computed physical location of the mobile stations and allocated access channel in to the RF information signal and transmitting the RF information signal to the mobile stations.

In accordance with still another aspect of the present invention, there is also provided a computer readable recoding medium for storing instructions of a method for computing a physical location of mobile stations and sharing information including the physical location in a bidirectional positioning system, the method including the steps of: a) at a positioning server, providing a reference time to a mobile station by transmitting a radio frequency (RF) information signal with the reference time through a wireless communication channel, and providing the reference time to a plurality of ultrasonic transceivers by transmitting a reference signal with the reference time through a wired communication channel; b) at a plurality of ultrasonic transceivers, measuring receiving times with correspondence mobile stations by receiving the ultrasonic signal and delivering the measured receiving times and the ultrasonic signal to the positioning server; c) at the positioning sever, computing physical locations of the mobile stations by receiving the receiving times of correspondence mobile stations from at least three different ultrasonic transceivers, storing the computed physical locations of the mobile stations and allocating an access channel to the mobile station; and d) at the positioning server, generating a radio frequency (RF) information signal by inserting information about the computed physical location of the mobile stations and allocated access channel in to the RF information signal and transmitting the RF information signal to the mobile stations.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram showing a conventional positioning system;

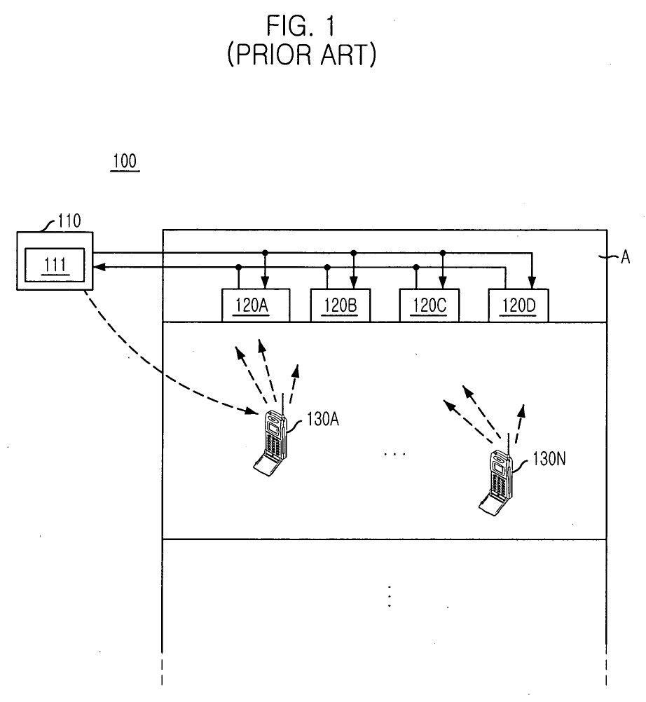

FIG. 2 is a block diagram illustrating a bidirectional positioning system in accordance with a preferred embodiment of the present invention;

FIG. 3 is a block diagram showing a frame structure of a radio frequency (RF) information signal transmitted from a RF transmitter in a positioning server in accordance with a preferred embodiment of the present invention;

FIG. 4 is a diagram illustrating a frame structure of an ultrasonic information signal in accordance with a preferred embodiment of the present invention; and

FIG. 5 is a flowchart explaining operations of bidirectional poisoning system in accordance with a preferred embodiment of the present invention.

### DETAILED DESCRIPTION OF THE INVENTION

Hereinafter, a bidirectional positioning system in accordance with a preferred embodiment of the present invention will be described in more detail with reference to the accompanying drawings.

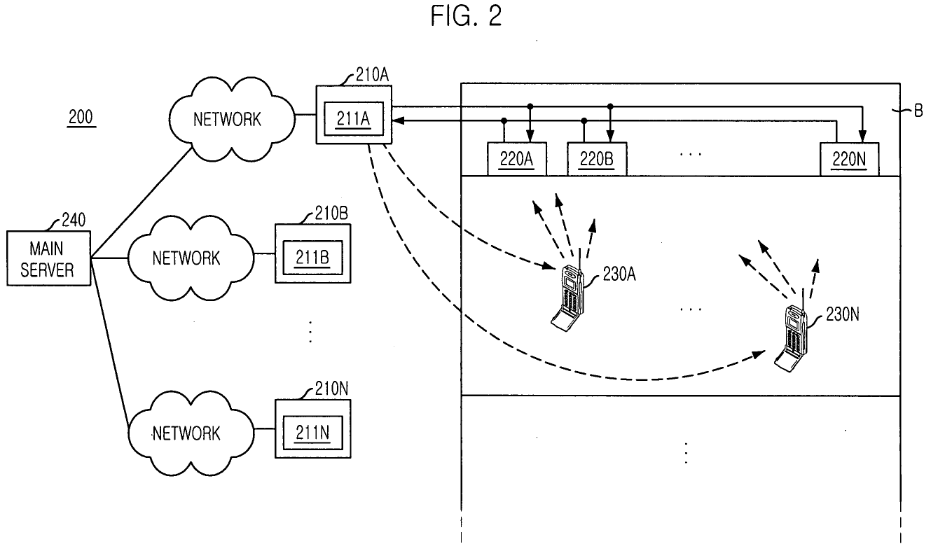

FIG. 2 is a block diagram illustrating a bidirectional positioning system in accordance with a preferred embodiment of the present invention.

As shown, the bidirectional positioning system 200 includes a plurality of positioning servers 210A to 210N, a plurality of ultrasonic transceivers 220A to 220N installed an indoor place B, a plurality of mobile stations 230A to 230N capable of radiating a ultrasonic signal and a main server 240 connected to the plurality of positioning servers 210A to 210N through the Internet network.

The plurality of positioning servers 210A to 210N periodically transmits a radio frequency (RF) information signal to the plurality of mobile stations 230A to 230N through a wireless communication channel and also transmits a reference signal to the plurality of ultrasonic transceivers 220A to 220D through a wired communication channel. In the bidirectional positioning system 200, the plurality of the mobile stations 230A to 230N are communicated with the plurality of ultrasonic transceivers 220A to 220N based on a time division multiple access (TDMA) for sharing a communication channel between the plurality of ultrasonic transceivers 220A to 220N and the plurality of mobile stations 230A to 230N. Therefore, the plurality of the mobile stations 230A to 230N and the plurality of ultrasonic transceivers 220A to 220D must be synchronized. The plurality of positioning servers 210A to 210N transmits the RF information signal and the reference signal to the plurality of mobile stations 230A to 230N and the plurality of ultrasonic transceivers 220A to 220D, respectively, by including a reference time for synchronization.

The plurality of positioning servers 210A to 210N computes physical locations of the plurality of mobile stations 230A to 230N based on a triangulation method by collecting receiving times of the ultrasonic signal radiated from the plurality of the mobile stations 230A to 230N to the plurality of ultrasonic transceivers 220A to 220N. The plurality of positioning servers 210A, 210B stores the computed physical positions of the plurality of mobile stations 230A to 230N at a database (not shown).

The plurality of positioning servers 210A to 210N provides information about physical location of corresponding mobile station by inserting desired information into the RF information signal and transmitting the RF information signal to the mobile station. Upon a request from the plurality of mobile stations, the plurality of positioning servers 210A to 210N provides addition information about physical location of neighbor mobile stations and regional information to the plurality of mobile stations 210A to 210N.

Each of the positioning servers 210A to 210N includes RF transmitters 211A to 211N, respectively. The RF transmitters 211A to 211N transmit a RF information signal for transmitting information to the plurality of mobile stations 230A to 230N through the wireless communication channel. As mentioned above, the RF information signal includes the reference time for synchronization, the physical location information of a mobile station and the additional information.

The plurality of the positioning servers 210A to 210N is distinguished according to a region of managing the plurality of mobile stations. The plurality of the positioning servers 210A to 210N is connected to the main server 240 through the Internet networks and the main server 240 centrally manages information about physical locations of mobile stations collected and computed by the plurality of positioning servers 210A to 210N. Accordingly, if a mobile station requires information about other mobile stations managed by other positioning servers, the main server 240 can provide desired information to the mobile station.

The plurality of mobile stations 230A to 230N receives the RF information signal and periodically radiates the ultrasonic signal after synchronization in response to the reference time included in the RF information signal.

The plurality of ultrasonic transceivers 220A to 220N receives the ultrasonic signal radiated from the plurality of mobile stations 230A to 230N and measures the receiving time of the ultrasonic signal. The plurality of ultrasonic transceivers 220A to 220N transmits the receiving time and information included in the ultrasonic signal to corresponding one of the plurality of positioning server 210A to 210N.

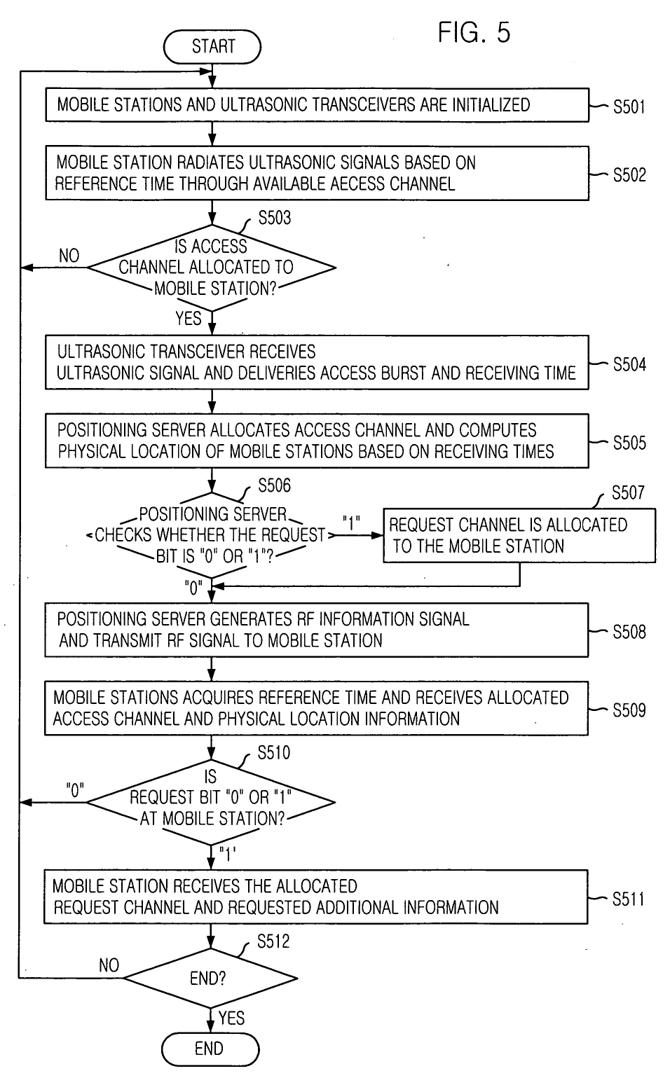

Detailed operations of the bidirectional positioning system 200 will be described in later with referring to FIG. 5.

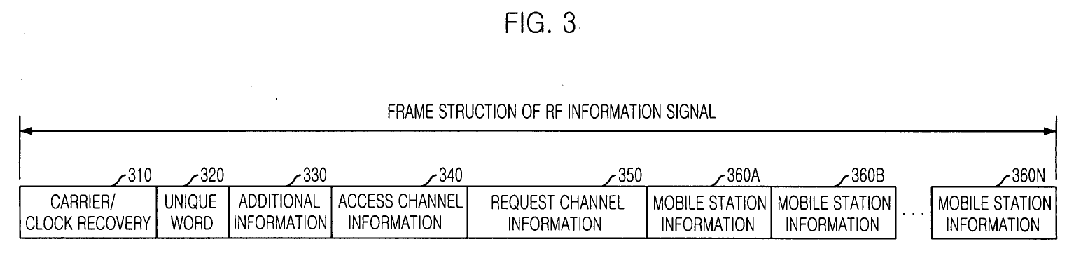

FIG. 3 is a block diagram showing a frame structure of a RF information signal transmitted from a RF transmitter in a positioning server in accordance with a preferred embodiment of the present invention.

A positioning server periodically transmits a RF information signal to mobile stations. The mobile station acquires a reference time from the RF information signal for synchronization with a plurality of ultrasonic transceivers in order to communication each others in the time division multiple access (TDMA) mode. In order words, there are a number of the mobile stations existed under management of one positioning server and the mobile stations radiate the ultrasonic signals based on the TDMA mode. Therefore, the mobile stations transmit the ultrasonic signal based on the reference time for avoiding collision of ultrasonic signals simultaneously transmitted from two or more mobile stations.

The mobile station also acquires information about available access channels to transmit ultrasonic signal to the plurality of ultrasonic transceivers, an allocated access channel and a request channel to send a request burst to the plurality of ultrasonic transceivers.

As shown, for providing necessary information including the reference time and available access channels to the mobile station, the RF information signal includes a carrier/clock recovery field 310, a unique word field 320, an additional information field 330, an access channel information field 340, a request channel information field 350 and a plurality of mobile station information fields 360A to 360N each of which including physical location information of correspondence mobile station.

The carrier/clock recovery field 310 and the unique word field 320 contain information for acquiring the reference time by decoding information included in the RF information signal.

The additional information field 330 contains additional information requested by the mobile station.

The access channel information field 340 contains information about available access channels, allocated access channel and currently used access channels.

The request channel information field 350 contains information about state of request channels, available request channel and allocated request channel.

The plurality of physical location information fields 360A to 360N contains physical location information corresponding to the mobile stations.

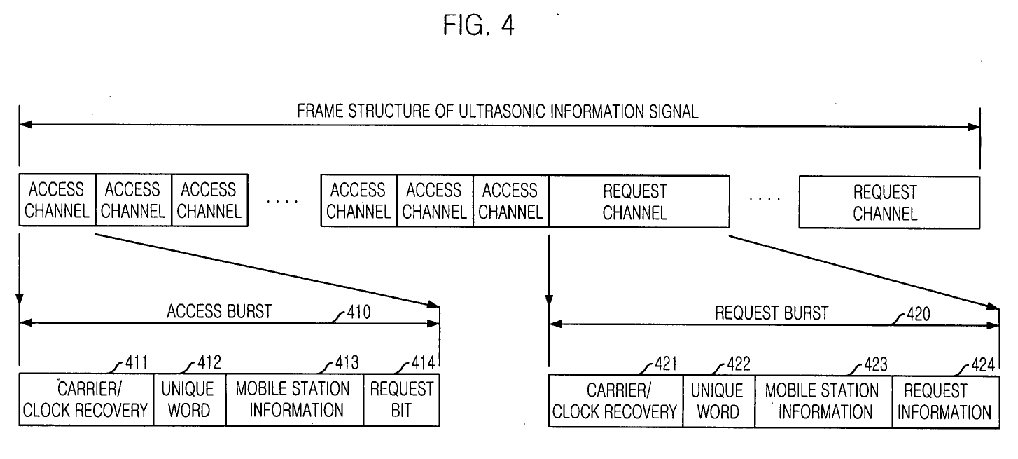

FIG. 4 is a diagram illustrating a frame structure of an ultrasonic information signal in accordance with a preferred embodiment of the present invention.

In a bidirectional positioning system, a plurality of mobile stations radiates an ultrasonic signal for noticing physical locations of the mobile stations and requesting desired additional information such as location information of another mobile station to the positioning server.

An ultrasonic wave is used as the ultrasonic signal to compute a physical location of a mobile station in the bidirectional positioning system since the ultrasonic wave has characteristics such as short wavelength that make possible to accurately compute the physical location of moving object such as the mobile station comparing to other signal. However, the ultrasonic signal is low frequency signal so a bandwidth of the ultrasonic signal is narrow and a data transmission rate of the ultrasonic signal is slow as much as several kbps. Therefore, the ultrasonic signal must be effectively used.

As shown in FIG. 4, a communication channel between the mobile station and the ultrasonic transceiver includes a plurality of access channels and a plurality of request channels. One of the plurality of access channels is allocated to a mobile station for noticing a physical location of the mobile station to the positioning server. One of the plurality of request channel is allocated to a mobile station for requesting desired information to the positioning server.

When noticing the physical location, the mobile station periodically radiates the ultrasonic signal by including an access burst 410.

The access burst 410 includes a carrier/clock recovery field 411, an unique word field 412, a mobile station information field 413 and a request bit field 414.

The carrier/clock recovery field 411 and the unique word field 412 include information for decoding information included in the access burst 410.

The mobile station information field 413 includes information about mobile station identification (ID).

The request bit field 414 contains information for noticing that the mobile station requests addition information to the positioning server. If the mobile station requests the additional information to the positioning server, the request bit field 414 set to “1” and otherwise set to “0”. The positioning server allocates one of information request channels to the mobile station for sending a request burst to the ultrasonic transceiver. After allocating the information request channel, the mobile station sends the ultrasonic signal by including the request burst to the ultrasonic transceiver for requesting desired additional information to the positioning system.

The request burst 420 includes a carrier/clock recovery field 421, an unique word field 422, a mobile station information field 423 and a request information field 424.

The carrier/clock recovery field 412 and the unique word field 422 contain information to decode information included in the request burst 420.

The mobile station information field 423 contains information about a mobile station identification (ID).

The request information field 424 contains information about what kind of additional information is required.

FIG. 5 is a flowchart explaining operations of bidirectional poisoning system in accordance with a preferred embodiment of the present invention.

At step S501, a plurality of mobile stations and a plurality of ultrasonic transceivers under management of a positioning server are initialized. In the step S501, the positioning server transmits a RF information signal to the plurality of mobile stations by inserting a reference time and available access channel information into the RF information signal through a wireless communication channel. Also, the positioning server transmits a reference signal to the plurality of ultrasonic transceivers by inserting the reference time into the reference signal through a wired communication channel. The plurality of ultrasonic transceivers and the plurality of mobile stations are synchronized based on the reference time for communicating each other in a time division multiple access (TDMA) mode. Furthermore, the plurality of mobile stations randomly selects one of available access channels based on an access channel information field included in the RF information signal in order to communicate to the plurality of the ultrasonic transceivers.

After initialization at the step S501, the plurality of mobile stations radiates an ultrasonic signal based on the reference time through the selected access channel at step S502. In the step S502, the plurality of mobile stations sets a request bit field included in the ultrasonic signal as “0” when there is no request for additional information or sets the request bit field as “1” when there are requests for additional information.

If access channels are not allocated to the mobile stations in a predetermined time period after radiating the ultrasonic signal at step S503, operations of the step S501 are repeatedly performed. Otherwise, the plurality of ultrasonic transceivers receives the ultrasonic signal and deliveries an access burst included in the ultrasonic signal and a receiving time of ultrasonic transceiver to the positioning servers at step S504. In the step S504, the plurality of ultrasonic transceivers measures a time when the ultrasonic signal radiated from one of mobile stations is arrived at the plurality of ultrasonic transceivers as the receiving time.

The positioning server collects receiving times of each mobile station from at least three different ultrasonic transceivers and computes a physical location of mobile stations based on the collected receiving times by using a triangular method at step S505. In the step S505, the computed physical location of each mobile station is stored in a database and the selected access channel is allocated to the mobile station as a fixed access channel.

After allocating the fixed access channel, the positioning server determines whether the request bit field is “0” or “1” at step S506.

If the channel request bit field is “1” then the positioning system allocates one of the request channels to the mobile station by selecting one of available request channels at step S507. In the step S507, if there is no available mobile station burst channels then the positioning server does not response to the mobile station.

If the request bit field is “0” then the positioning system does not allocate one of request channels to the mobile station and the positioning server generates a RF information signal by inserting information about the computed physical locations of the plurality of mobile stations and the allocated access channels and transmits the RF information signal to the plurality of mobile stations by using the RF transmitter at step S508. In the step S508, if the mobile station requests additional information by setting the request bit field as “1”, the positioning server additionally inserts information about the allocated request channel and additional information into the RF information signal.

At step S509, the plurality of the mobile stations acquires reference time and receives the allocated access channel and the physical location information included in the RF information signal.

If a request bit of a mobile station is “0” at the step S510, operations of the step S501 is repeatedly performed.

If the request bit of the mobile station is “1” at step S510, the mobile station acquires the request information channel or request additional information from the RF information signal at step S511.

At step S512, it is determined whether the bidirectional positioning system terminates processes of finding locations of the plurality of mobile stations.

If the processes are terminated, the processes are ended and if the processes are not terminated then the steps 501 to 511 are repeatedly performed.

As mentioned above, operations of the bidirectional positioning system can be implemented as a set of instructions and the set of instructions can be stored in a computer readable recoding medium such as a floppy disk, a RAM, a ROM, a CD-ROM, a hard disk and an optical magnetic disk.

As mentioned above, the present invention can accurately measure a physical location of mobile station by using a triangulation method with ultrasonic signals radiated from the mobile station.

Also, the present invention shares information about the physical location of mobile station with the positioning system and the mobile stations by managing the information about the physical location of mobile station at the positioning server and transmitting a RF information signal including the information from the positioning server to the mobile stations.

Furthermore, in the present invention, a mobile station can request additional information by sending request information through an ultrasonic transceiver to the positioning system, and the mobile station can receive requested additional information from the positioning server with the RF information signal.

The present application contains subject matter related to Korean patent application No. KR 2003-0083200, filed in the Korean patent office on Nov. 21, 2003, the entire contents of which being incorporated herein by reference.

While the present invention has been described with respect to certain preferred embodiments, it will be apparent to those skilled in the art that various changes and modifications may be made without departing from the sprit and scope of the invention as defined in the following claims.

1. A bidirectional positioning system including a plurality of mobile stations radiating ultrasonic signals to notice a physical location of correspondence mobile station and to request additional information, the bidirectional positioning system, comprising:
a plurality of ultrasonic transceivers for receiving the ultrasonic signal from the plurality of mobile stations and measuring a receiving time of the ultrasonic signal with a correspondence mobile station; and
a positioning server for computing physical locations of the plurality of mobile stations by collecting three or more receiving times of correspondence mobile station from the plurality of ultrasonic transceivers, storing the computed physical locations of the plurality of mobile stations in a database, generating a radio frequency (RF) information signal to have information about computed physical location of the mobile stations by receiving the ultrasonic signal from the plurality of ultrasonic transceivers and transmitting the RF information signal to the mobile stations.

2. The bidirectional positioning system of claim 1, wherein the plurality of ultrasonic transceivers deliveries the ultrasonic signal from the plurality of mobile station to the positioning server for passing information about access channel randomly selected by the plurality of mobile stations and requests of additional information requested by the plurality of mobile stations.

3. The bidirectional positioning system of claim 1, wherein the positioning server transmits a reference signal having a reference time to the plurality of ultrasonic transceivers through a wired communication channel and transmits the RF information signal having the reference time to the plurality of mobile stations through a wireless communication channel for synchronizing the plurality of ultrasonic transceivers and the plurality of mobile stations with the reference time in order to communicate each others in a time division multiple access (TDMA) mode.

4. The bidirectional positioning system of claim 1, wherein the positioning server allocates access channels to the plurality of mobile stations for transmitting the ultrasonic signal to the plurality of ultrasonic transceivers and generates the RF information signal in response to the ultrasonic signal to include information about allocated access channels.

5. The bidirectional positioning system of claim 1, wherein the positioning server allocates request channels to the plurality of mobile stations, which requests additional information to the positioning server, in response to an ultrasonic signal transmitted from the mobile station, generates the RF information signal including the additional information requested by the mobile station and transmits the RF information signal to the mobile station.

6. The bidirectional positioning system of claim 1, wherein the ultrasonic signal transmitted from the plurality of the mobile station includes an access burst and a request burst.

7. The bidirectional positioning system of claim 6, wherein the access burst includes a carrier/clock recovery field, an unique word field, a mobile station information field and a request bit field, wherein the carrier/clock recovery field and the unique word field contain information for encoding information in the access burst, the mobile station information field contains information about a correspondence mobile station such as mobile station identification and the request bit field for indicating there is a request for additional information.

8. The bidirectional positioning system of claim 7, wherein the request bit field is set to “0” when there is no request and is set to “1” when there are requests.

9. The bidirectional positioning system of claim 6, wherein the positioning system allocates one of request channels to a correspondence mobile station in response to the access burst when the request bit field is set to “1” and generates the RF information signal by inserting information about the allocated request channel.

10. The bidirectional positioning system of claim 9, wherein the mobile station transmits the request burst by inserting information about what kind of additional information is requested and the positioning server generates the RF information signal by inserting additional information requested from the mobile station in response to the request burst delivered from the plurality of ultrasonic transceivers.

11. The bidirectional positioning system of claim 10, wherein the request burst includes a carrier/clock recovery field, an unique word field, a mobile station information field and a requested information field, wherein the carrier/clock recovery field and the unique word field contain information for encoding information in the access burst, the mobile station information field contains information about a correspondence mobile station such as mobile station identification and the request information field contains information about what kinds of information is requested.

12. The bidirectional positioning system of claim 11, wherein the additional information is information about a physical location of other mobile station and regional information where the mobile station located.

13. The bidirectional positioning system of claim 1, wherein the RF information signal includes a carrier/clock recovery field, a unique word field, an additional information field, an access channel information field, a request channel information field and a plurality of physical location information fields, wherein the carrier/clock recovery field and the unique word field contain information for acquiring a reference time by decoding information included in the RF information signal, the additional information field contains additional information requested, the access channel information field contains information about available access channels, allocated access channel and currently used access channels, the request channel information field contains information about state of request channels, available request channel and allocated request channel and the plurality of physical location information fields contains physical location information corresponding to the mobile stations.

14. The bidirectional positioning system of claim 1, wherein each of the plurality of the mobile stations radiates the ultrasonic signals for noticing the physical location, sending information about access channel and requesting additional information to the positioning server and receives the RF information signal from the positioning server for synchronizing with the plurality of the ultrasonic transceiver, receiving information of the own physical location, receiving information of physical locations of other mobile stations and receiving additional requested information.

15. A method for computing a physical location of mobile stations and sharing information including the physical location in a bidirectional positioning system, the method comprising the steps of:
a) at a positioning server, providing a reference time to a mobile station by transmitting a radio frequency (RF) information signal with the reference time through a wireless communication channel, and providing the reference time to a plurality of ultrasonic transceivers by transmitting a reference signal with the reference time through a wired communication channel;
b) at a plurality of ultrasonic transceivers, measuring receiving times with correspondence mobile stations by receiving the ultrasonic signal and delivering the measured receiving times and the ultrasonic signal to the positioning server;
c) at the positioning sever, computing physical locations of the mobile stations by receiving the receiving times of correspondence mobile stations from at least three different ultrasonic transceivers, storing the computed physical locations of the mobile stations and allocating an access channel to the mobile station; and
d) at the positioning server, generating a radio frequency (RF) information signal by inserting information about the computed physical location of the mobile stations and allocated access channel in to the RF information signal and transmitting the RF information signal to the mobile stations.

16. The method of claim 15 further comprising the steps of:
e) at the positioning server, allocating a request channel to the mobile station which request additional information to the positioning server; and
f) at the positioning server, transmitting the additional information when the mobile station request additional information through the allocated request channel.

17. The method of claim 16, wherein in the step e), the request channel is allocated by receiving an access burst with a request bit field which is set to “1” included in the ultrasonic signal from the ultrasonic transceiver through the allocated access channel at the positioning server.

18. The method of claim 17, wherein in the step f), the additional information is transmitted by receiving a request burst with a request information field containing information about what kind of additional information is request from the mobile station through the allocated request channel at the positioning server.

19. The method of claim 14, wherein in the step c), the physical location of the mobile station is computed by using a triangulation method with the collected receiving times of correspondence mobile station from at least three different ultrasonic transceivers.

20. A computer readable recoding medium for storing instructions of a method for computing a physical location of mobile stations and sharing information including the physical location in a bidirectional positioning system, the method comprising the steps of:
a) at a positioning server, providing a reference time to a mobile station by transmitting a radio frequency (RF) information signal with the reference time through a wireless communication channel, and providing the reference time to a plurality of ultrasonic transceivers by transmitting a reference signal with the reference time through a wired communication channel;
b) at a plurality of ultrasonic transceivers, measuring receiving times with correspondence mobile stations by receiving the ultrasonic signal and delivering the measured receiving times and the ultrasonic signal to the positioning server;
c) at the positioning sever, computing physical locations of the mobile stations by receiving the receiving times of correspondence mobile stations from at least three different ultrasonic transceivers, storing the computed physical locations of the mobile stations and allocating an access channel to the mobile station; and
d) at the positioning server, generating a radio frequency (RF) information signal by inserting information about the computed physical location of the mobile stations and allocated access channel in to the RF information signal and transmitting the RF information signal to the mobile stations.
